(19) United States
(12) Patent Application Publication
(10) Pub. No.: US 2009/0326227 A1
(43) Pub. Date: Dec. 31, 2009

(54) Process for the Preparation of Biphosphonic Acids and Salts Thereof

(75) Inventors: Joana Baptista, Lisbon (PT); Zita Mendes, Lisbon (PT)

Correspondence Address: MACMILLAN SOBANSKI & TODD, LLC, ONE MARITIME PLAZA FIFTH FLOOR, 720 WATER STREET, TOLEDO, OH, 43604-1619, US

(73) Assignee: HOVIONE INTER LIMITED, Lucerne 7 (CH)

(21) Appl. No.: 12/513,740

(22) PCT Filed: Nov. 6, 2007
(86) PCT No.: PCT/GB07/04229

§ 371 Date: Jul. 27, 2009

(30) Foreign Application Priority Data
Nov. 6, 2006 (PT) 103600

(51) Int. Cl. C07F 9/38; C07F 9/6506; C07F 9/58

(52) U.S. Cl. 546/22; 562/22; 548/119

(57) ABSTRACT

A process for the preparation of biphosphonic acids and pharmaceutical acceptable salts thereof, comprises reacting a carboxylic acid with phosphorous trichloride and phosphorous acid in the presence of an aprotic polar solvent. Formula (I):

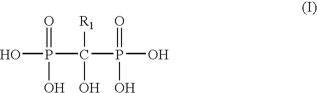

The present invention relates to a process for the preparation of biphosphonic acids and salts thereof.

Biphosphonic compounds, known as biphosphonates, form a class of pharmaceutically active substances used for the treatment of bone diseases and dysfunctions of calcium metabolism. Such diseases include, but are not limited to, osteoporosis, Paget's disease and osteolytic metastasis.

Biphosphonates are analogues of an endogenous substance known as pyrophosphoric acid which is a natural inhibitor of bone resorption. Pyrophosphoric acid is characterised by its P—O—P bond. However, pyrophosphoric acid cannot be used as a therapeutic agent because the P—O—P bond undergoes rapid enzymatic hydrolysis, so pyrophosphoric acid has a short biological half-life. There is, therefore, a need for synthetic analogues of pyrophosphoric acids which are less readily hydrolysed. Biphosphonates are synthetic analogues of pyrophosphoric acid where the central atom of oxygen is substituted by a carbon atom—forming a P—C—P bond—as presented in formula I. This modification allows the biphosphonates to be more resistant to enzymatic hydrolysis leading to a higher biological half-life (t₅₀), sufficient to influence the bone metabolism. As a result, biphosphonates are useful therapeutically active substances.

Biphosphonates have the following general structure:

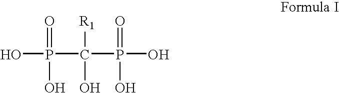

where R1 can have the following, non limitative meanings, as presented in Table I:

TABLE I

| | Chemical Name |
|---|---|
| R1 Structure | of final Product |
| R1 = CH₃ | Etidronic acid |
| 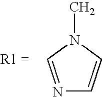 | Zoledronic acid |
| 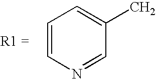 | Risedronic acid |
| 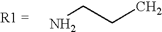 | Pamidronic acid |
| 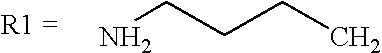 | Alendronic acid |
| 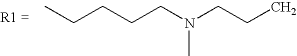 | Ibandronic acid |

Biphosphonates are generally synthesised by a process comprising reaction of a carboxylic acid, or a salt thereof, in the presence of phosphorous acid (H₃PO₃) and phosphorous trichloride (PCl₃).

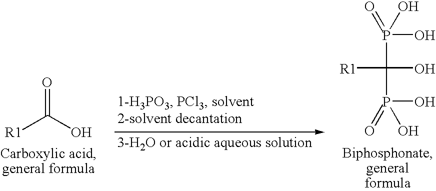

Known processes for manufacturing biphosphonate compounds suffer from several disadvantages, including solidification of the reaction mixture, which leads to difficulties in the industrialisation of the process and reproducibility of yields.

European patent EP 0 186 405 describes a process for synthesising biphosphonates, comprising reaction of a carboxylic acid with H₃PO₃ and PCl₃, in an inert polar solvent, which is chlorobenzene, at a temperature of about 100° C. The procedure described in this patent does not provide further technical information but from the brief summary presented it can be concluded that there are serious technical issues that have to be overcome in order to scale up this process into an industrial procedure.

The process taught in EP 0186405 suffers from several disadvantages. These disadvantages include a requirement to add the PCl₃ reagent to the reaction mixture at a temperature higher than the boiling point of the reagent. This necessitates addition of the reagent at an unsafe adiabatic temperature, especially at larger reaction volumes, which have decreased cooling capability. In addition, solidification of the reaction mixture occurs, forming a vitreous solid. After reaction completion, a hydrolysis reaction occurs by the addition of water (a hydrolysing agent); however, the reaction solvent is immiscible with water, so it is necessary to remove the reaction solvent, by decantation, before the addition of water. This introduces an extra process step. Furthermore, the addition of hydrolysing agent can trigger an uncontrolled exothermic reaction due to destruction of PCl₃ pockets that may be present in the solidified reaction mass. A further disadvantage is that the process has a variable yield.

European patent EP 1 243 592 discloses an alternative process for synthesising biphosphonates. This process differs from the process taught in EP 0 186 405 in that it employs fluorobenzene as the reaction solvent, and minor alterations to the work-up procedure have been introduced in order to isolate the biphosphonate compound in a single reaction step. However, these alterations do not eliminate the problem of solidification of the reaction mixture.

Other processes for manufacturing biphosphonates, employing alternative reaction solvents, are known.

Use of methanesulfonic acid as the reaction solvent is known (J. Org. Chem. 1995, 60; 8310-8312). Use of methanesulfonic acid minimises the solidification of the reaction mixture, but the yield reported is very low. In addition, methanesulfonic acid has toxicity and environmental issues and its use as solvent should be avoided in industrial processes.

European Patent EP 1 656 386 describes a synthetic process for manufacturing biphosphonates that employs sulfolane as the reaction solvent. Sulfolane is a class II solvent and although this patent mentions that the reaction mixture is a homogeneous mixture, reproduction of this process at industrial scale has been found to lead to difficulties because of the necessity of distilling the phosphorous acid at reduced pressure.

European patent EP 1 252 169 discloses a process for the preparation of biphosphonates without solvent, with higher molar equivalents of H₃PO₃:PCl₃, 5:2 to 10:4, where H₃PO₃ is used as a reagent and solvent and in the presence of a base, preferably morfoline. The reaction mixture is described as a stirrable homogeneous system in the form of viscous oil, but only at high temperatures, which are undesirable.

According to the present invention there is provided a process for producing a biphosphonic acid compound which process comprises reacting a carboxylic acid compound or a salt thereof with phosphorous acid and phosphorous trichloride in an aprotic polar solvent.

According to a preferred embodiment, there is provided a process for producing a biphosphonic acid compound of the general formula I or a pharmaceutically acceptable salt thereof

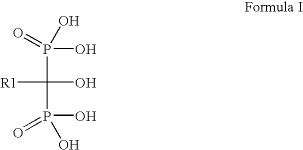

which process comprises reacting a carboxylic acid compound of formula II, or a salt thereof

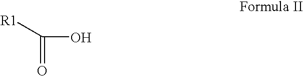

wherein R1 is alkyl, arylalkyl, aromatic or heteroaromatic group, with phosphorous acid and phosphorous trichloride in an aprotic polar solvent, optionally comprising the addition of a hydrolysing agent. Typically, the addition of the hydrolyzing agent follows completion of the main reaction. Preferably, a hydrolysing agent is added. Any suitable hydrolysing agent may be used, although water is a preferred hydrolysing agent.

Thus, in one embodiment, there is provided a process for producing a biphosphonic acid compound of the general formula I or a pharmaceutically acceptable salt thereof

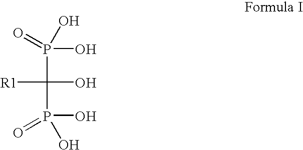

which process comprises reacting a carboxylic acid compound of formula II, or a salt thereof

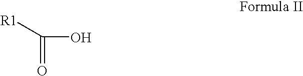

wherein R1 is alkyl, arylalkyl, aromatic or heteroaromatic group, with phosphorous acid and phosphorous trichloride in an aprotic polar solvent, followed by the addition of water.

Surprisingly, we have found that use of a mixture of carboxylic acid, H₃PO₃ and PCl₃ in the presence of an aprotic polar solvent leads to a reaction mixture in the form of a stirrable homogeneous dispersion at a temperature of, for example, about 20° C. or higher, eliminating the problem of solidification of the reaction mixture at lower temperatures.

We have also found that use of a mixture of carboxylic acid, H₃PO₃ and PCl₃ in the presence of an aprotic polar solvent has several further advantages. These further advantages include improved safety because the mixture forms a stirrable homogeneous dispersion. Another advantage of the invention is improved yield: the yields are higher than those disclosed for prior art processes.

We have found that the process of the present invention has reduced cycle time and work-up simplification, and can be easily scaled up to an industrial scale process.

Another advantage of the present invention is that the process involves green chemistry, because only Class II solvents, and stoichiometric amounts of reagents, are used.

We have found that the process enables isolation of biphosphonic acids and pharmaceutically acceptable salts thereof with high purity, in a one-step reaction, and with higher and reproducible yields.

The present process preferably involves reacting a carboxylic acid of formula II, or a salt thereof

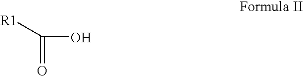

wherein R1 is alkyl, arylalkyl, aromatic or heteroaromatic group, with phosphorous acid and phosphorous trichloride in an aprotic polar solvent.

By “alkyl” we mean a linear or branched aliphatic hydrocarbon group. Examples of alkyl groups include methyl, propyl, isopropyl, butyl, isobutyl, pentyl, hexyl, heptyl and the like. A branched alkyl means a linear alkyl substituted with a lower alkyl (that is, by an alkyl group having fewer carbon atoms in the chain than the linear alkyl). Methyl is a preferred alkyl group. Optionally, the alkyl may be a substituted alkyl. Substituted alkyls include alkyl groups wherein one or more hydrogen atoms is replaced by a functional group such as, for example, a hydroxy group or an amino (—NH₂) group. Preferred substituted alkyls include (CH₂)₃NH₂ and (CH₂)₄NH₂. Optionally, the alkyl group is a heteroalkyl group. The term “heteroalkyl group” includes linear or branched alkyl groups where one or more carbon atoms has been replaced with a heteroatom, such as nitrogen, sulphur or oxygen. Preferably, the heteroatom is a nitrogen atom. A preferred heteroalkyl group is, for example, (CH₂)₃NCH₃(CH₂)₄CH₃.

By “arylalkyl”, we mean an aryl group which is substituted with a linear or branched alkyl (as defined above). “Aryl” means an aromatic cyclic hydrocarbon such as, for example, phenyl or naphthyl.

By “aromatic” group we mean to include groups comprising a conjugated planar ring system having delocalised electrons. Aromatic groups can comprise, for example, 5- or 6-membered rings. Aromatic groups include monocyclic and polycyclic aromatic groups. For example, aromatic groups include phenyl, naphthyl and the like. Optionally, the aromatic group may be substituted, for example with an alkyl group.

By “heteroaromatic group” we mean an aromatic group as defined above comprising one or more non-carbon ring atoms, such as oxygen, nitrogen or sulfur. For example, heteroaromatic groups include pyridyl, pyrimidyl, pyrazolyl, and the like. Optionally, the heteroaromatic group may be substituted.

Preferably, R1 is selected from the following groups:

| | Chemical Name |
|---|---|
| R1 Structure | of final Product |
| R1 = CH₃ | Etidronic acid |
| 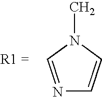 | Zoledronic acid |
| 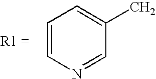 | Risedronic acid |
| 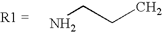 | Pamidronic acid |
| 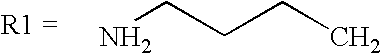 | Alendronic acid |
| 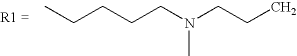 | Ibandronic acid |

The reaction is carried out in an aprotic polar solvent. Any suitable aprotic polar solvent may be used. Preferred solvents include N,N′-dimethylethyleneurea (DMEU), N,N′-dimethylpropyleneurea (DMPU), 1-methyl-2-pyrrolidone (NMP), acetonitrile, and mixtures of two or more thereof. DMEU is a particularly preferred polar aprotic solvent. A preferred mixture of solvents is a mixture of DMEU and acetonitrile. DMEU and acetonitrile may be employed in any suitable ratio by volume. However, a preferred ratio of DMEU to acetonitrile is 75:25 by volume.

Optionally, the process further comprises addition of a hydrolysing agent, preferably water. Preferably, the process further comprises addition of a hydrolysing agent. If a hydrolysing agent is used, the polar aprotic solvent may advantageously be chosen to be miscible with the hydrolysing agent, as this leads to simplification of the work-up procedures. Water is a preferred hydrolysing agent, so advantageously the aprotic polar solvent is miscible with water. For example, DMEU is miscible with water, so DMEU is a preferred polar aprotic solvent.

The reaction of carboxylic acid, phosphorous acid and phosphorous trichloride may be carried out at any suitable temperature. A reaction temperature of from 20° C. to 100° C. is preferred. More preferably, the reaction temperature is from 30° C. to 85° C. A reaction temperature of from 40° C. to 70° C. is most preferred.

It is preferred that the biphosphonate compound of formula I, or a salt thereof, is isolated directly from the reaction mixture without removal of the reaction solvent.

Preferably, the bisphosphonic acid (I) is obtained from the reaction mixture after the addition of water. More preferably, a biphosphonic acid salt is isolated from the reaction mixture by a process comprising the addition of water, a pH adjustment and the addition of an alcohol, preferably a C₁ to C₅ alcohol.

The following Examples are intended to illustrate particularly preferred embodiments, and do not limit the present invention.

### EXAMPLE 1

### Preparation of Risedronic Acid Sodium Salt

A mixture of 3-pyridylacetic acid (7.5 g; 0.0432 mol) and H₃PO₃ (5.31 g; 0.0648 mol) in N,N′-dimethylethyleneurea (DMEU) (30 ml) is heated to a temperature of from 40° C. to 50° C. PCl₃ (7.5 ml; 0.0852 mol) is slowly added to the resulting suspension. The resulting mixture is heated to a temperature of from 50° C. to 60° C. and stirred until the reaction is complete. Reaction completion is monitored by HPLC. Water is slowly added to the reaction mixture and the resulting solution is heated, with stirring, at a temperature of from 80° C. to 100° C. until reaction is complete. The reaction mixture is cooled to ambient temperature and the pH is adjusted to about pH 8 to 9 with aqueous sodium hydroxide solution. The resulting solution is filtered and the pH of the solution is adjusted to pH 4.5 to 5.0. Ethanol is added and precipitation of solids occurs. The solid is filtered, washed and dried under vacuum at a temperature of from 45° C. to 55° C. to a constant weight. 8.9 g of risedronic acid sodium salt, hemipentahydrate is obtained (molar yield: 60%) with a HPLC purity higher than 99.5% in area. [The yield was calculated on dry basis]

The product was characterised as follows:

¹H NMR (D₂O) δ=3.40 (t., 2H, CH₂); 7.70 (dd., 1H, CH); 8.20 (dm., 1H, CH); 8.40 (d., 1H, CH); 8.64 (s., 1H, CH)

³¹P NMR (D₂O) δ=18.26

X-Ray 2θ/°=8.9, 12.2, 12.9, 24.6, other peaks 2θ/°=13.5, 19.8, 27.8, 31.3

### EXAMPLE 2

### Preparation of Risedronic Acid, Free Acid

A mixture of 3-pyridylacetic acid (25 g; 0.142 mmol) and H₃PO₃ (17.7 g; 0.216 mol) in N,N′-dimethylethyleneurea (DMEU) (100 ml) is heated to a temperature of from 40° C. to 50° C. PCl₃ (25.2 ml; 0.284 mol) is slowly added to the resulting suspension. The resulting mixture is heated to a temperature of from 50° C. to 60° C. and stirred until reaction is complete. Reaction completion is monitored by HPLC. Water is slowly added to the reaction mixture and the resulting solution is heated, with stirring, at a temperature of from 80° C. to 100° C. until the reaction is complete. The reaction mixture is cooled to ambient temperature and the pH is adjusted to about pH 8 to 9 with aqueous sodium hydroxide solution. The resulting solution is filtered and the pH of the solution is adjusted to pH 1.5 to 2.0. Ethanol is added and precipitation of solids occurs. The solid is filtered, washed and dried under vacuum at a temperature of from 45° C. to 55° C. to a constant weight.

The product was characterized as follows:

¹H NMR (D₂O) δ=3.35 (t., 2H, CH₂); 7.71 (dd., 1H, CH); 8.36 (d., 1H, CH); 8.44 (d., 1H, CH); 8.62 (s., 1)

### EXAMPLE 3

### Preparation of Crude Risedronic Acid, Free Acid

A mixture of 3-pyridylacetic acid (7.5 g; 0.0432 mol) and H₃PO₃ (5.31 g; 0.0648 mol) in N,N′-dimethylethyleneurea (DMEU) (30 ml) is heated to a temperature of from 40° C. to 50° C. PCl₃ (7.5 ml; 0.0852 mol) is slowly added to the resulting suspension. The resulting mixture is heated to a temperature of from 50° C. to 60° C. and stirred until the reaction is complete by HPLC. Water is slowly added to the reaction mixture and the resulting solution is heated, with stirring, to a temperature of from 80° C. to 100° C. until the reaction is complete. The reaction mixture is cooled to ambient temperature The solid is filtered, washed and dried under vacuum at a temperature of from 45° C. to 55° C. until constant weight. 12.9 g of crude risedronic acid is obtained.

### EXAMPLE 4

### Preparation of Zoledronic Acid, Free Acid

A mixture of 1-imidazolylacetic acid (25 g; 0.1538 mol) and H₃PO₃ (18.9 g; 0.2306 mol) in N,N′-dimethylethyleneurea (DMEU) (150 ml) is heated to a temperature of from 40° C. to 50° C. PCl₃ (26 ml; 0.3076 mol) is slowly added to the resulting suspension. The resulting mixture is heated to a temperature of from 50° C. to 60° C. and stirred until reaction is complete by HPLC. Water is slowly added to the reaction mixture and the resulting solution is heated, with stirring, to a temperature of from 80° C. to 100° C. until the reaction is complete. The reaction mixture is cooled to ambient temperature and the pH is adjusted to pH 8.0 to 9.0 with aqueous sodium hydroxide solution. The resulting solution is filtered and the pH of the solution is adjusted to pH 1.5 to 2.0. Ethanol is added and precipitation of solids occurs. The solid is filtered, washed and dried under vacuum at a temperature of from 45° C. to 55° C. to a constant weight. 25.7 g of zoledronic acid is obtained (molar yield: 85.6%) with a HPLC purity higher than 99.5% in area. [The yield was calculated on dry basis]

The product was characterized as follows:

¹H NMR (D₂O) δ=4.71 (t., 2H, CH₂); 7.28 (dd., 1H, CH); 7.44 (dd., 1H, CH); 8.62 (s., 1H, CH)

³¹P NMR (D₂O) δ=16.03

1. A process for producing a biphosphonic acid compound which process comprises reacting a carboxylic acid compound or a salt thereof with phosphorous acid and phosphorous trichloride in an aprotic polar solvent selected from N,N′-dimethylethyleneurea (DMEU), N,N′-dimethylpropyleneurea (DMPU), 1-methyl-2-pyrrolidone (NMP), or a mixture of two or more thereof.

2. A process according to claim 1 wherein the biphosphonic acid compound is of the general formula I or a pharmaceutically acceptable salt thereof 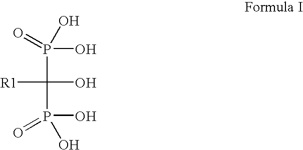
which process comprises reacting a carboxylic acid compound of formula II, or a salt thereof 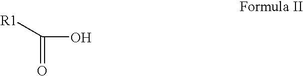
wherein R1 is alkyl, arylalkyl, aromatic or heteroaromatic group, with phosphorous acid and phosphorous trichloride in an aprotic polar solvent selected from N,N′-dimethylethyleneurea (DMEU), N,N′-dimethylpropyleneurea (DMPU), 1-methyl-2-pyrrolidone (NMP), or a mixture of two or more thereof.

3. A process according to claim 1 further comprising addition of a hydrolysing agent.

4. A process according to claim 3 wherein the hydrolysing agent is water.

5. A process according to claim 2 wherein R1 is one of the following:

| | Chemical Name |
|---|---|
| R1 Structure | of final Product |
| R1 = CH₃ | Etidronic acid |
| 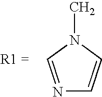 | Zoledronic acid |
| 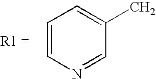 | Risedronic acid |
| 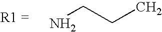 | Pamidronic acid |
| 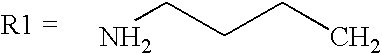 | Alendronic acid |
| 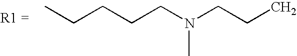 | Ibandronic acid |

6. A process according to claim 1, wherein the carboxylic acid is 3-pyridylacetic acid or a salt thereof.

7. A process according to claim 1, wherein the carboxylic acid is 1-imidazolylacetic acid or a salt thereof.

8. A process according to claim 3, wherein the aprotic polar solvent is miscible with the hydrolysing agent.

9. A process according to claim 1, wherein the solvent is N,N′-dimethylethyleneurea (DMEU).

10. A process according to claim 1, wherein N,N′-dimethylethyleneurea (DMEU) and acetonitrile are used as solvents in the ratio 75:25 by volume.

11. A process according to claim 1, wherein the reaction of the carboxylic acid, phosphorous acid and phosphorous trichloride is carried at a temperature of from 20° C. to 100° C.

12. A process according to claim 1, wherein the reaction of the carboxylic acid, phosphorous acid and phosphorous trichloride is carried out at a temperature of from 40° C. to 70° C.

13. A process according to claim 1, wherein a compound of formula I is isolated as the biphosphonic acid or a pharmacological acceptable salt thereof, directly from the reaction mixture without removal of the reaction solvent.

14. A process according to claim 1, wherein the biphosphonic acid is obtained from the reaction mixture after the addition of water.

15. A process according to claim 2 further comprising addition of a hydrolysing agent.

16. A process according to claim 15, wherein the hydrolysing agent is water.

17. A process according to claim 3 wherein R1 is one of the following:

| | Chemical Name |
|---|---|
| R1 Structure | of final Product |
| R1 = CH₃ | Etidronic acid |
| 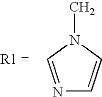 | Zoledronic acid |
| 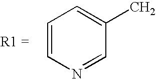 | Risedronic acid |
| 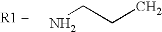 | Pamidronic acid |
| 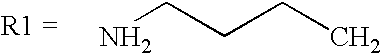 | Alendronic acid |
| 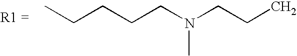 | Ibandronic acid |

18. A process according to claim 15 wherein R1 is one of the following:

| | Chemical Name |
|---|---|
| R1 Structure | of final Product |
| R1 = CH₃ | Etidronic acid |
| 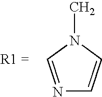 | Zoledronic acid |
| 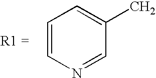 | Risedronic acid |
| 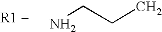 | Pamidronic acid |
| 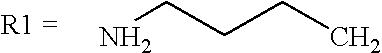 | Alendronic acid |
| 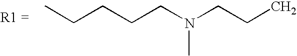 | Ibandronic acid |

19. A process according to claim 4 wherein R1 is one of the following:

| | Chemical Name |
|---|---|
| R1 Structure | of final Product |
| R1 = CH₃ | Etidronic acid |
| 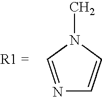 | Zoledronic acid |
| 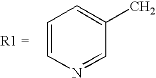 | Risedronic acid |
| 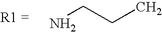 | Pamidronic acid |
| 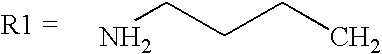 | Alendronic acid |
| 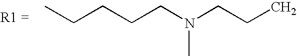 | Ibandronic acid |

20. A process according to claim 16 wherein R1 is one of the following:

| | Chemical Name |
|---|---|
| R1 Structure | of final Product |
| R1 = CH₃ | Etidronic acid |
| 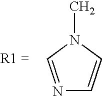 | Zoledronic acid |
| 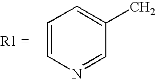 | Risedronic acid |
| 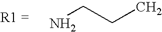 | Pamidronic acid |
| 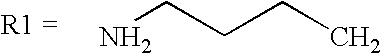 | Alendronic acid |
| 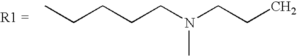 | Ibandronic acid |
